(19) United States
(12) Patent Application Publication
(10) Pub. No.: US 2011/0038690 A1
(43) Pub. Date: Feb. 17, 2011

(54) METHOD FOR ATTACHING A BOOKCOVER TO GLUE-COATED OUTSIDE SURFACES OF A BOOK BLOCK TO BE ENCASED

(75) Inventor: Christian GANTER, Bieberehren (DE)

Correspondence Address: VENABLE LLP, P.O. BOX 34385, WASHINGTON, DC, 20043-9998, US

(73) Assignee: Mueller Martini Holding AG, Hergiswil (CH)

(21) Appl. No.: 12/854,500

(22) Filed: Aug. 11, 2010

(30) Foreign Application Priority Data
Aug. 17, 2009 (EP) 09405139.8

(51) Int. Cl. B42C 9/00

(52) U.S. Cl. 412/4

(57) ABSTRACT

A method for producing a book in which a center strip is attached to an inside of a back of a book cover that is to be glue-coated to outside surfaces of a book block to be encased in the book cover. The method includes conveying the book block, with glue on outside surfaces while positioned straddling along a conveying section, along a conveying path in a direction advancing toward a book cover positioned at a right angle to the conveying section. The book cover has a cover back positioned approximately evenly in a conveying plane formed by the book block advancing toward the inside of the book cover back while straddling the conveying section. The cover sections of the book cover are pressed against outside surfaces of the book block along conveying path to attach the book cover to the book block. Prior to the pressing, the book cover is gripped at least in a center region that forms the book cover back in order to lift up the center region in the advancing direction of the book block.

### CROSS-REFERENCE TO RELATED APPLICATION

This application claims the priority of European Patent Application No. 09405139.8, filed on Aug. 17, 2009, the subject matter of which is incorporated herein by reference.

### BACKGROUND OF THE INVENTION

The invention relates to a method for attaching a book cover to the glue-coated outside surfaces of a book block to be encased for producing a book, wherein this book cover is provided with a center strip or back insert on the inside of the casing back. With this method, the book blocks which are conveyed in a straddling position on a conveying section and are respectively provided with glue on the outside surfaces are advanced in the direction toward the inside of a book cover which is oriented approximately evenly toward a conveying plane, formed by the book blocks conveyed on the conveying section, so that during the further conveying operation along the joint path, the book cover can be attached to the book block by pressing its inside areas against the outside surfaces of the book block.

Independent of the method, the invention also relates to a device for attaching a book cover, provided on the inside along the back with a center strip, to the glue-coated outside surfaces of a book block for producing a book. This type of device is used in a casing-in machine. Such device includes two pressing rollers forming a pressing device which can move back and forth along a conveying section of a conveyor belonging to a casing-in machine. The rollers are arranged opposite each other along the vertical conveying section and function to press respectively one glue-coated outside surface of a book block to one inside surface of the casing that is conveyed upward along the conveying section while positioned straddling on a saddle plate. The conveying section has a support plane that extends at a right angle to the conveying direction and is intended for the book cover, distributed evenly over the saddle plate. Positioning rails are provided that can be adjusted relative to the conveying plane and are arranged on both sides of the conveying plane formed by the driven saddle plates.

A method and a device of the aforementioned type are disclosed, among other things, in the German patent documents DE 43 34 224 A1, DE 43 34 225 A1, DE 101 10 319 A1, and European patent documents EP 1 072 436 A1 and EP 1 780 038 A1, as well as in the book “INDUSTRIELLE BUCHBINDEREI” [Industrial Bookbinding] by Liebau/Heinze, Edition 2001, ISBN3-88013-596-7, pages 468-475 and pages 480-483.

With a book block casing-in machine as disclosed in the EP 1 072 436 A1, the danger exists that a casing ready for the processing is lifted up without control by an upward-moving book block and, in the process, is displaced before the pressing rollers of the pressing device can secure the position of the book cover on the book block back. That is due to the circumstance that the pressing device is accelerated by the book block to the speed of the book block before the book cover is taken over. The document EP 1 780 038 A1, paragraphs 0003 and 0004, describe the mode of operation of a machine for encasing a book block with a book cover.

With a known book block casing-in machine, utilized in a book-processing or a book-binding line of the type “Diamant” by Muller Martini AG, a positioning device is used just prior to pressing the book cover against the outside areas of a book block, so as to obtain a high book quality and high production reliability. The positioning device consists of two positioning rails which are respectively arranged on each side of a conveying plane for the book blocks, conveyed while positioned straddling on saddle plates, and which can be pivoted against each other or away from each other in a direction transverse to the conveying direction. The spacing on the side for the positioning rails, which form a gap with an obtuse angle at the end opposite the book cover back, is respectively adapted and/or adjusted to a specific width dimension for the back of the book cover to be encased with a book block and functions to center the book block which is raised by the saddle plate toward the back of the book cover in the conveying plane formed by a circulating conveyor. The operational mode of this positioning device, which is considered state of the art, is illustrated with Figures 1a, 1b and 1c. FIG. 1a shows the starting position between a book block and/or a saddle plate and the pressing device where the positioning device that is attached to the pressing device is lowered to the joint region or center region of the casing provided with a center strip on the back. According to FIG. 1b, position is subsequently reached for synchronizing the movements of the book block and the pressing device in which the positioning device is again far from the joint region of the book cover. Following this, the movements of the pressing device and the book block and/or the saddle plate of the conveyor are synchronized as shown in FIG. 1c.

This operation requires mechanical and technical control devices which can considerably hinder the production reliability and the production quality.

### SUMMARY OF THE INVENTION

It is an object of the present invention to provide a method and a device for attaching a book cover that is provided with a center strip on the casing back to the glue-coated outside surfaces of a book block to be encased, and in particular to simplify the production method and to improve the production reliability and quality as compared to the known designs.

The above and other objects are accomplished according to an embodiment of the invention wherein there is provided a method for producing a book in which a center strip is attached to an inside of a back of a book cover that is to be glue-coated to outside surfaces of a book block to be encased in the book cover, the method comprising: conveying the book block, with glue on outside surfaces while positioned straddling along a conveying section, along a conveying path in a direction advancing toward a book cover positioned at a right angle to the conveying section, wherein the book cover has a cover back positioned approximately evenly in a conveying plane formed by the book block advancing toward the inside of the book cover back while straddling the conveying section; pressing cover sections of the book cover against outside surfaces of the book block along conveying path to attach the book cover to the book block; and prior to the pressing, gripping the book cover at least in a center region that forms the book cover back in order to lift up the center region in the advancing direction of the book block.

According to a further aspect of the invention there is provided a device to attach a book cover, with a center strip on a back of an inside of the book cover, to glue-coated outside surfaces of a book block to be encased in a casing-in machine for producing a book, the casing-in machine including a conveyor having a vertical conveying section comprising a vertically moveable saddle plate defining a conveying plane, the device comprising, according to one embodiment: a pressing device including two pressing rollers arranged opposite each other along the vertical conveying section of the conveyor and controllable to move back and forth along the conveying section of the conveyor, wherein the rollers respectively press one section of the book cover against a glue-coated outside surface of the book block that is positioned straddling on the saddle plate and conveyed in an upward direction along the conveying section, wherein a support plane is arranged at a right angle to the conveying direction for the book cover to be positioned uniformly straddling the saddle plate; and positioning rails arranged on the pressing device, respectively one on each side of the conveying plane that is formed by the driven saddle plate, wherein the positioning rails are adjustable relative to the conveying plane, wherein the positioning rails have ends facing the book cover that jointly comprise a controllable gripper that can be opened and closed.

The method and the device according to the invention may be used for books where the book block thicknesses range is from approximately 2 to 4 mm.

### BRIEF DESCRIPTION OF THE DRAWINGS

These and other features and advantages of the invention will be further understood from the following detailed description of the preferred embodiments with reference to the accompanying drawing, to which we refer for all details not further mentioned herein, wherein this drawing shows:

FIG. 1a illustrates a cross-sectional view through a known device, showing sections of a casing-in machine used in a book production line according to the prior art.

FIG. 1b illustrates the device shown in FIG. 1a, following a further production step.

FIG. 1c illustrates the device according to FIG. 1b, following yet a further production step.

FIG. 2 illustrates a cross section through a casing-in machine according to the invention, used in a book production line, showing a situation before a book block is encased in a book cover.

FIG. 2a illustrates an enlarged representation of a positioning rail in the gripper region, in accordance with FIG. 2.

FIG. 3 illustrates a device as shown in FIG. 2, following a further processing step.

FIG. 4 illustrates the device according to FIG. 3, showing yet another processing step in which the book cover is lifted up.

FIG. 5 shows the device illustrated in FIG. 4, showing a different processing step where the book cover is lifted up even further.

FIG. 6 shows the device illustrated in FIG. 5, showing another processing step prior to pressing the book cover against the book block; and

FIG. 7 shows the device illustrated in FIG. 6 during a further processing step showing the pressing of the book cover against the outside areas of the book block.

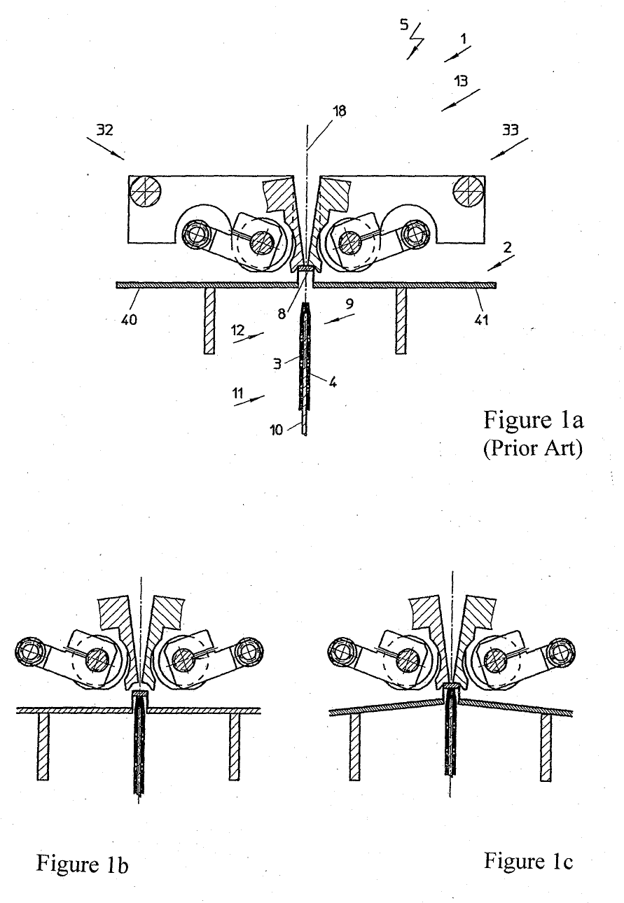

### DETAILED DESCRIPTION

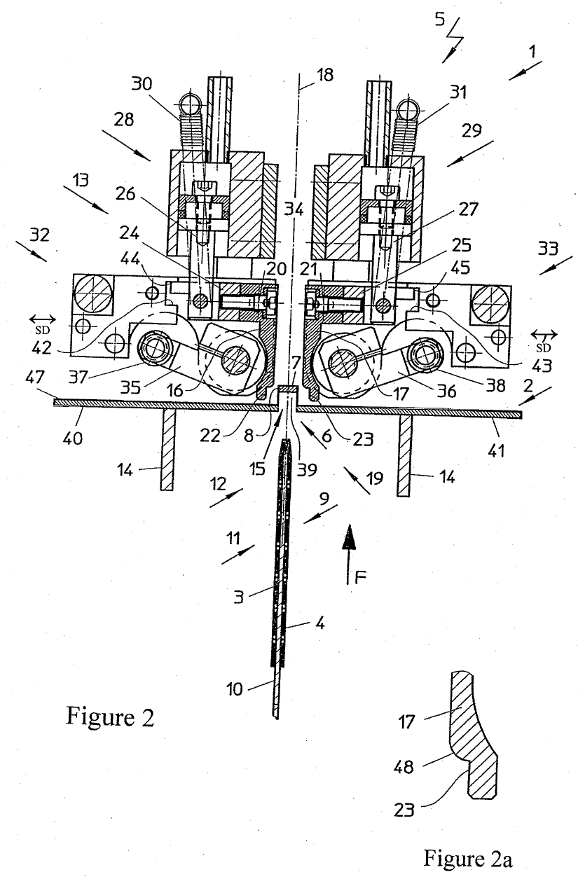

FIGS. 2 to 7 show a device 1 according to the invention for attaching a book cover 2 to the glue-coated outer surfaces 3, 4 of a book block 9, to be encased in a casing-in machine 5 for producing a book. The book cover 2 has a center strip 8 attached to the inside 6 of the cover back 7. The device 1 is part of the casing-in machine 5 which has a saddle plate 10 on a circulating, state of the art conveyor 11 which is supplied by a processing section with the book blocks 9 (for example see the German patent document DE 43 34 224 A1 and European patent document EP 1 780 038 A1). The conveyor 11 comprises a vertical conveying section 12 on which the book blocks 9 are supplied from below and are encased by pressing a casing 2 against the surfaces 3, 4 with the aid of a pressing device 13. Above the saddle plate 10 which is shown carrying a book block 9, a book cover 2 is positioned distributed on a frame 14, ready for encasing a book block 9, wherein a region 15 forming the joint of the book cover 2 and/or a center section 15 of the reference cover 47 projects in an upward direction over the book cover 2. Above the book cover 2, the pressing device 13 is in a reversing position from which it subsequently moves in an upward direction.

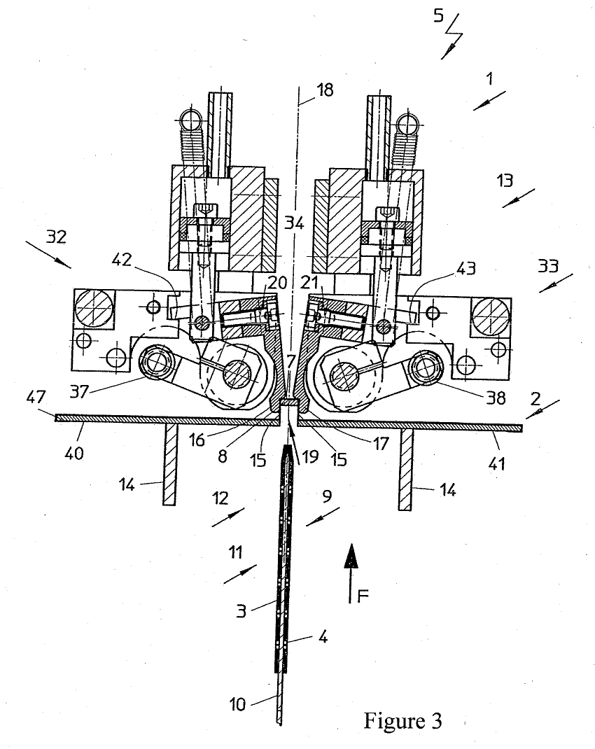

Positioning rails 16, 17 have ends facing toward the saddle plate 10 that form a gripper 19 with the Positioning rails 16, 17 are pivotable as shown in FIGS. 2 to 7, wherein the pivoting movement is delimited by the end stops 42, 44 and 43, 45. The horizontal pivoting axes 20, 21 of the positioning rails 16, 17 are located above the gripper 19. At the ends of the positioning rails 16, 17 that are arranged opposite the conveying plane 18, the gripper 19 is provided with recesses 22, 23 which grip and/or partially encircle in a force-locking and form-locking manner the center strip 8 in the center region of the book cover 2. The recesses 22, 23 may be shaped to form approximately a right angle, so that during a pivoting movement of the positioning rails 16, 17, they can additionally and lightly grip the center strip 8 from below (see FIG. 3).

Of course, the positioning rails 16, 17 could also be moved back and forth approximately at a right angle to the conveying plane 18 for forming the gripper 19, for example with the aid of a pneumatic drive or a rack and pinion drive.

The region of transition illustrated in FIG. 2a which extends from the flat side of a positioning rail 16, 17 that is facing the passage 34 to the associated recess 22, 23 is embodied to have a round shape 48. During a joint advancing of the positioning rails 16, 17 and/or during the closing of the gripper 19, this shape promotes a careful insertion of the joint region 15, which partially encloses the center strip 8, into the gripper 19 and/or prevents damage to the joint region 15 when it is gripped during the closing of the gripper 19.

As illustrated in FIGS. 2-7, the positioning rails 16, 17 may be designed for a pivoting movement and are shown respectively connected to a lever device including support 24, 25 which can be pivoted back and forth around the pivoting axes 20, 21. The support, in turn, is connected via a drive rod 26, 27 to a pneumatic piston-cylinder unit 28, 29, wherein the piston-cylinder unit 28, 29 causes the closing movement of the gripper 19 while the torsion springs 30, 31, coupled to the supports 24, 25, cause the opening movement of the gripper 19.

With the aid of a guide arrangement, such as a spindle drive, schematically indicated by double arrows SD in FIG. 2, adapted to the different book thicknesses, the passage 34 for the finished books 46 may be adjusted between the positioning rails 16, 17 which are respectively connected to a pressing carriage 32, 33 of the pressing device 13. FIGS. 2 to 7 furthermore show pressing rollers 37, 38 which are respectively positioned with pivoting arms 35, 36 on the pressing carriages 32, 33, wherein FIGS. 2 to 5 shows these pressing rollers being pivoted back to the non-operating position.

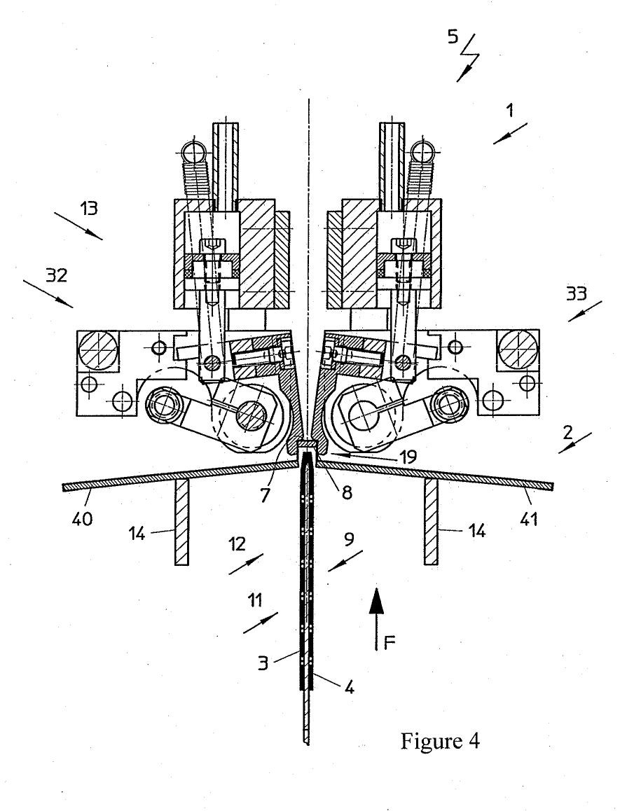

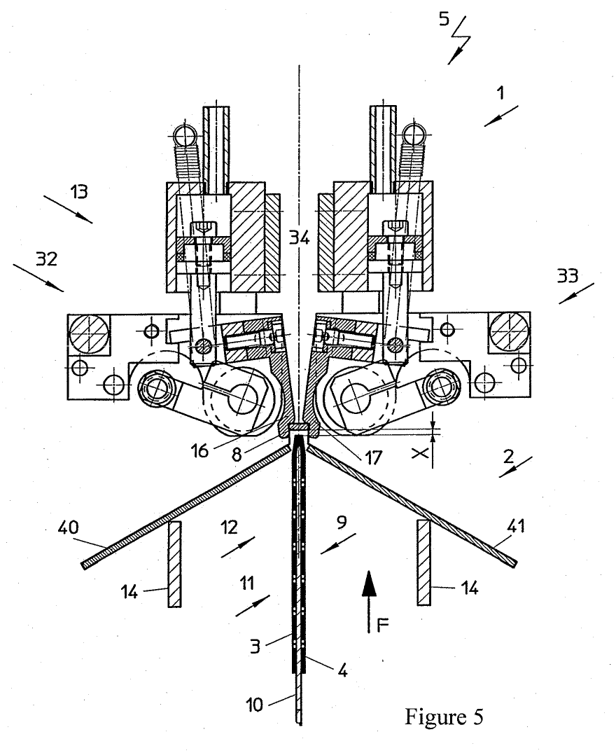

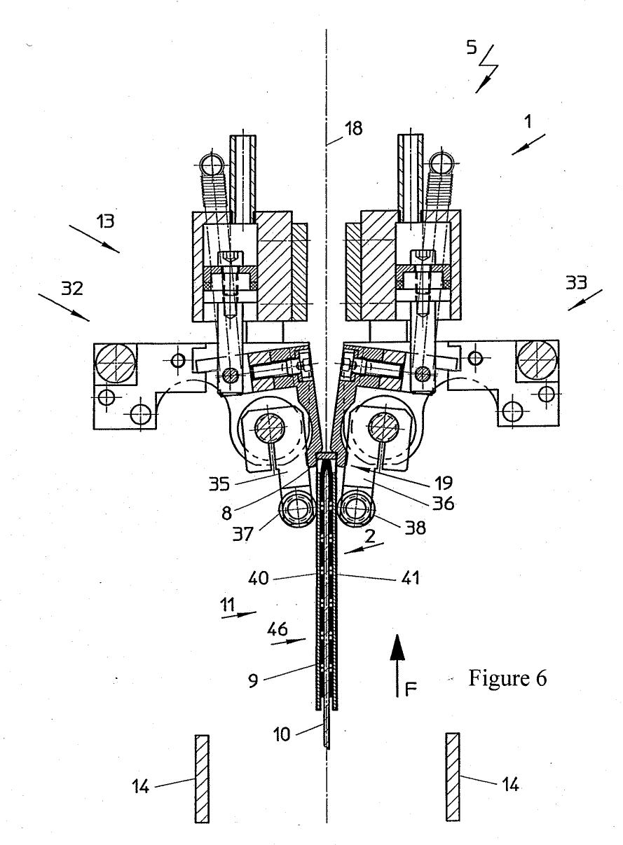

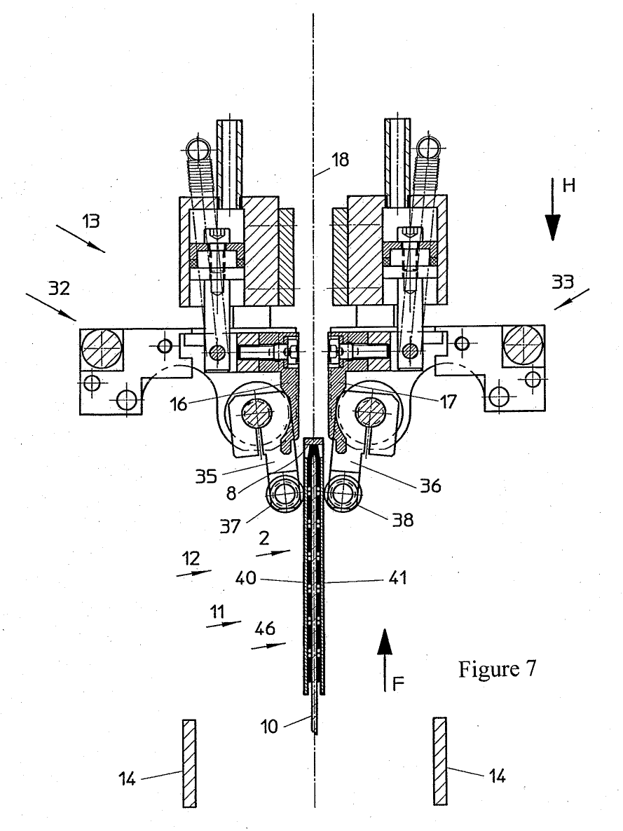

With the aid of FIGS. 2 to 7, the mode of operation and the operating position of the device 1 are described in the following for processing the book cover 2 and the book block 9 to produce a book. As previously mentioned, FIG. 2 shows a starting position for the device 1. Based on the situation illustrated in FIG. 3, the positioning rails 16, 17 that form the gripper 19 have gripped the book cover back 7 along the longitudinal edges of the center strip 8, partially enclosing the cover back 7 in a force-locking and form-locking manner, and the book block 9, positioned on the saddle plate 10, has advanced further toward the book cover. According to FIG. 4, the pressing device 13 has been accelerated to move upward from the position shown in FIGS. 2 and 3, the book cover 2 has been raised in the center region in the manner of a hip roof by the gripper 19, and the book block back is being inserted into the raised up joint region 15. The speed of the book cover 2 may then be synchronized with the speed of the saddle plate 10, as indicated in FIG. 5, so that a hollow space 39 with the distance measure X remains between the book block back and the center strip 8 during the continued encasing operation. This distance measure X can be set to zero or adjusted so as to prevent the book cover 2 from exerting any pressure onto the book block back. Until this instance and/or processing point, the pressing rollers 37, 38 are in the idle position. The pressing operation only starts following this processing point, as shown in FIG. 6. Following another upward movement, the book block 9 reaches the center strip 8 and the book cover sections 40, 41 of the book cover 2 have been pulled in over the frame 14 and, as a result of their inherent weight, pivoted against the outside surfaces 3, 4 of the book block 9. Subsequently, the pressing rollers 37, 38 are pivoted from the non-operating position to the operating position against the book cover sections 40, 41, are pressed against these sections, and are then moved downward while the saddle plate 10 moves continuously in upward direction (see FIG. 7).

It will be understood that the above description of the present invention is susceptible to various modifications, changes and adaptations, and that the same are intended to be comprehended within the meaning and range of equivalents of the appended claims.

What is claimed is:

1. A method for producing a book in which a center strip is attached to an inside of a back of a book cover that is to be glue-coated to outside surfaces of a book block to be encased in the book cover, the method comprising:
conveying the book block, with glue on outside surfaces while positioned straddling along a conveying section, along a conveying path in a direction advancing toward a book cover positioned at a right angle to the conveying section, wherein the book cover has a cover back positioned approximately evenly in a conveying plane formed by the book block advancing toward the inside of the book cover back while straddling the conveying section;
pressing cover sections of the book cover against outside surfaces of the book block along conveying path to attach the book cover to the book block; and
prior to the pressing, gripping the book cover at least in a center region that forms the book cover back in order to lift up the center region in the advancing direction of the book block.

2. The method according to claim 1, wherein the gripping includes gripping the book cover along the book cover back to lift up the book cover back.

3. The method according to claim 2, wherein the gripping includes gripping the book cover back in a side region of the center strip.

4. The method according to claim 1, including forming a distance between the center strip and the book block back so that a hollow space remains between the center strip and the book block back, once the book block is encased.

5. The method according to claim 1, wherein the advancing includes lifting the book cover up with a speed that is lower than a speed at which the book block is conveyed in the conveying step.

6. A device to attach a book cover, with a center strip on a back of an inside of the book cover, to glue-coated outside surfaces of a book block to be encased in a casing-in machine for producing a book, the casing-in machine including a conveyor having a vertical conveying section comprising a vertically moveable saddle plate defining a conveying plane, the device comprising:
a pressing device including two pressing rollers arranged opposite each other along the vertical conveying section of the conveyor and controllable to move back and forth along the conveying section of the conveyor, wherein the rollers respectively press one section of the book cover against a glue-coated outside surface of the book block that is positioned straddling on the saddle plate and conveyed in an upward direction along the conveying section, wherein a support plane is arranged at a right angle to the conveying direction for the book cover to be positioned uniformly straddling the saddle plate; and
positioning rails arranged on the pressing device, respectively one on each side of the conveying plane that is formed by the driven saddle plate, wherein the positioning rails are adjustable relative to the conveying plane, wherein the positioning rails have ends facing the book cover that jointly comprise a controllable gripper that can be opened and closed.

7. The device according to claim 6, wherein the ends of the positioning rails forming the gripper each include respective recesses arranged opposite each other with respect to the conveying plane.

8. The device according to claim 7, wherein the recesses are shaped to define an approximate right angle.

9. The device according to claim 6, wherein the positioning rails are pivotable around a horizontal axis arranged parallel to the conveying plane for the opening and closing of the gripper.

10. The device according to claim 9, further including end stops to delimit the pivoting movements of the positioning rails that form the gripper.

11. The device according to claim 6, wherein the positioning rails are arranged to move back and forth at an approximately right angle to the conveying plane for the opening and closing of the gripper.

12. The device according to claim 7, wherein each positioning rail includes a transition region having a rounded shape that extends from a flat region forming a passage for the book to the recess.

13. The device according to claim 9, further including a lever device arranged to pivot the positioning rails.

14. The device according to claim 6, further including two pressing carriages mounting the positioning rails that form a pressing device that is moveable by a guide arrangement along the conveying section, wherein a spacing between the pressing carriages is adjustable.
